(19) United States
(12) Patent Application Publication
(10) Pub. No.: US 2018/0104932 A1
(43) Pub. Date: Apr. 19, 2018

(54) ASYMMETRIC LAMINATES COMPRISING ASYMMETRIC MULTIPLE LAYER INTERLAYER

(71) Applicant: SOLUTIA INC, ST. LOUIS, MO (US)

(72) Inventor: JUN LU, EAST LONGMEADOW, MA (US)

(73) Assignee: SOLUTIA INC., ST. LOUIS, MO (US)

(21) Appl. No.: 15/297,858

(22) Filed: Oct. 19, 2016

(51) Int. Cl. B32B 17/10

(52) U.S. Cl. CPC B32B 17/1055; B32B 2307/102; B32B 17/10036

(57) ABSTRACT

An asymmetric multiple layer interlayer and an asymmetric sound insulating multiple layer panel is disclosed. The panel comprises a first rigid substrate having a first thickness, a second rigid substrate having a second thickness, wherein the first thickness is less than the second thickness, and an asymmetric multiple layer acoustic interlayer between the first and second rigid substrates, wherein the multiple layer comprises a first stiff layer having a first stiff layer thickness, a second stiff layer having a second stiff layer thickness, and an inner layer between the first and second outer layers, and wherein the inner layer is non-centrally located.

### BACKGROUND

### 1. Field of the Invention

This disclosure relates to asymmetric multiple layer interlayers and asymmetric multiple layer panels comprising an asymmetric multilayer interlayer. More specifically, the present invention discloses asymmetric multiple layer interlayers and asymmetric multiple layer panels or laminates comprising a first rigid sheet, a second rigid sheet having a different thickness than the first rigid sheet and a multiplayer acoustic interlayer comprising a first stiff layer, a second stiff layer, and a soft layer positioned non-centrally between and in contact with the stiff layers.

### 2. Description of Related Art

Poly(vinyl butyral) (PVB) is often used in the manufacture of polymer sheets that can be used as interlayers in multiple layer panels formed by sandwiching the interlayer between two sheets of glass or other rigid substrate. Such laminated glass or glass panel has long served for safety purposes and is often used as a transparent barrier in architectural and automotive applications. One of its primary functions is to absorb energy resulting from impact or a blow without allowing penetration of the object through the glass and to keep the glass bonded even when the applied force is sufficient to break the glass. This prevents dispersion of sharp glass shards, which minimizes injury and damage to people or objects within an enclosed area. Less known is the advantage of laminated glass for noise attenuation. Over the past decades, architectural use of laminated glass in buildings near airports and railways has served to reduce the noise levels inside the buildings, making it more comfortable for the occupants. Likewise this technology is now being used in buildings where street and highway traffic noise is a problem. Recently, advances in interlayer technology have made improved laminated glass that provides noise and vibration improvements for automotive glass. p Traditionally, glass panels used in automotive applications employ two glass sheets each having a thickness between 2.0 and 2.3 millimeters (mm). Most often, these sheets have approximately the same thickness. This type of configuration facilitates both strength and rigidity in the final panel, which, in turn, contributes to the overall mechanical strength and rigidity of the vehicle body. Some estimates attribute up to 30 percent of the overall rigidity of a vehicle to its glass. Thus, the design and rigidity of the multiple layer glass panels used for constructing vehicle glazings such as, for example, the windshield, sun or moon roof, and side and rear windows, are critical not only for the performance of those panels, but also for the overall performance of the vehicle itself.

Recent trends toward more fuel efficient vehicles have brought about demand for lighter weight vehicles. One way of reducing overall vehicle weight has been to reduce the amount of glass by using thinner glass sheets. For example, for a windshield having a surface area of 1.4 m², reducing the thickness of one of the panels by about 0.5 mm can result in a weight reduction of over 10 percent, all other things being equal.

One approach to thinner multiple layer panels has been to use an “asymmetric” glass configuration, wherein one of the panels is thinner than the other. Thinner glass panels with symmetric configurations have also been used. However, the asymmetric configurations are more often employed and involve using an “outboard” glass panel (i.e., the glass panel facing outside of the vehicle cabin) with a traditional 2.0 mm to 2.3 mm thickness and a thinner “inboard” glass panel (i.e., the glass panel facing the interior of the cabin). The thicker outboard glass is to ensure adequate strength and impact resistance against rocks, gravel, sand, and other road debris to which the outboard panel would be subjected during use. Typically, however, these asymmetric panels require a combined glass thickness of at least 3.7 mm in order to maintain properties such as deflection stiffness, glass bending strength, glass edge strength, glass impact strength, roof strength, and torsional rigidity within acceptable ranges.

Further, because asymmetric configurations are typically formed by utilizing a thinner inboard glass sheet, the sound insulation properties of these panels are often poorer than similar panels utilizing thicker glass. Therefore, in order to minimize road noise and other disturbances within the cabin, interlayers used to form asymmetric multiple layer panels are generally interlayers having acoustic or sound dampening or sound insulating properties (i.e., acoustic interlayers). Conventional, non-acoustic interlayers do not provide sufficient sound insulation for most applications requiring good sound insulation.

The interlayers, such as poly(vinyl acetal) or poly(vinyl butyral) polymers found in laminated safety glass (such as windshields), have typically had one or more physical characteristics modified in order to increase acoustic dampening and reduce the sound transmission through the glass. Acoustic interlayers are interlayers that minimize the resonance and coincident effect of glass and increase the sound transmission loss or sound insulation at resonance frequencies and in the coincident region. Acoustic interlayers can be monolithic sheets having low glass transition temperatures or multilayer interlayers having two or more adjacent layers of thermoplastic polymer wherein the layers have dissimilar characteristics (see, for example U.S. Pat. Nos. 5,340,654, 5,190,826, and 7,510,771). These multilayered interlayers may include at least one inner “core” layer sandwiched between two outer “skin” layers. Often, the core layer of a multilayer interlayer may be a softer layer having a lower glass transition temperature, which enhances its acoustic performance. However, because such soft layers can be difficult to easily process and/or transport, the skin layers of such multilayered interlayers are often stiffer, with higher glass transition temperatures, which imparts enhanced processability, strength, and impact resistance to the interlayer. In these multilayer interlayers having one soft core layer and two stiffer outer layers, the soft core layer is often positioned in the center of the interlayer, e.g., the soft core layer is centrally positioned or centrally configured (such as by having outer layers of the same or equal thickness).

While asymmetric multiple layer glass panels result in increased weight savings by reducing the thickness of the inboard glass sheet (compared to multiple layer panels having the same outboard glass sheet and a thicker inboard glass sheet), it is known that the symmetry of the glass configuration has a profound effect on noise transmission through the laminated glass panel containing an acoustic interlayer. Decreasing the symmetry of glass of the multiple layer panel (i.e., making the multiple layer panel less symmetric or more asymmetric) increases the noise transmission (that is, it reduces sound insulation), especially in the coincident frequency region, while increasing the symmetry of glass of the multiple layer panel decreases noise transmission or improves sound insulation (see, for example, U.S. patent application Ser. Nos. 15/061,418 and 15/061,488).

Thus, a need exists for an acoustic interlayer for use in multiple layer glass panels, and in particular, multiple layer glass panels with an asymmetric glass configuration, that exhibits sufficient acoustic performance and sound insulation. Desirably, such an interlayer could be widely used in glass panels for a variety of automotive, aerospace, and architectural applications.

### SUMMARY

One embodiment of the present invention is a multiple layer acoustic interlayer for a sound insulating asymmetric multiple layer panel comprising: a first stiff layer having a first stiff layer thickness, a second stiff layer having a second stiff layer thickness, a soft layer between the first and second stiff layers, and wherein the soft layer is non-centrally located.

Another embodiment of the present invention is a multiple layer acoustic interlayer for a sound insulating asymmetric multiple layer panel comprising: a first stiff layer having a first stiff layer thickness, a second stiff layer having a second stiff layer thickness, a third stiff layer having a third stiff layer thickness, a first soft layer between the first and second stiff layers, a second soft layer between the second and third stiff layers, wherein at least one of the first and second soft layers is non-centrally located.

Another embodiment of the present invention is an asymmetric sound insulating multiple layer panel comprising: a first rigid substrate having a first thickness H₃, a second rigid substrate having a second thickness H₁, wherein H₃<H₁, and an asymmetric multiple layer acoustic interlayer between the first and second rigid substrates, wherein the multiple layer comprises a first stiff layer having a first stiff layer thickness, a second stiff layer having a second stiff layer thickness, and a soft layer between the first and second stiff layers, and wherein the soft layer is non-centrally located.

### BRIEF DESCRIPTION OF THE DRAWINGS

FIG. 1a depicts a multiple layer glass panel with an symmetric glass configuration.

FIG. 1b depicts a multiple layer glass panel with an asymmetric glass configuration.

FIG. 2a shows a symmetric tri-layer interlayer with the soft layer positioned centered in the interlayer.

FIG. 2b shows an asymmetric tri-layer interlayer with the soft layer positioned off-center in the interlayer.

FIG. 3 is a graph of the sound transmission loss of several multiple layer panels formed and tested as described in Example 1.

FIG. 4 a graph of the sound transmission loss of several multiple layer panels formed and tested as described in Example 2.

FIG. 5 a graph of the sound transmission loss of several multiple layer panels formed and tested as described in Example 4.

FIG. 6 is a graph of the sound transmission loss of several additional multiple layer panels formed and tested as described in Example 4.

### DETAILED DESCRIPTION

The present invention discloses asymmetric multiple layer interlayers and asymmetric multiple layer panels comprising an asymmetric acoustic multilayer interlayer. More specifically, the present invention discloses asymmetric multiple layer panels or laminates comprising a first rigid substrate or sheet, a second rigid substrate or sheet having a thickness different from the first rigid substrate or sheet, and an acoustic interlayer between the first and second rigid substrates, wherein the acoustic interlayer comprises a core layer(s) or soft layer(s) that is non-centrally positioned in the interlayer. The acoustic interlayer may comprise more than one core layer or soft layer, as further described below.

Asymmetric multiple layer panels comprising asymmetric multiple layer interlayers according to the present invention improve sound insulation performance compared to conventional asymmetric panels having a symmetrically configured acoustic interlayer where the core layer is centrally positioned in the interlayer. The sound insulation of the multiple layer panel can be further improved with an asymmetric multilayer interlayer that comprises at least two soft layers where at least one of the soft layers is non-centrally positioned such that the interlayer is asymmetric. In embodiments, the asymmetric multilayer glass panel having an asymmetrically configured multilayer interlayer improves sound insulation as measured by sound transmission loss in the coincident frequency region by up to 1.0, up to 1.5, up to 1.7, up to 2.0, up to 2.5, up to 2.7, up to 3.0, up to 3.5, up to 4.0, or up to 4.2 decibels (dB) over a conventional asymmetric laminated glass panel having the same combined glass thickness and a symmetrically configured multiplayer acoustic interlayer.

Multiple layer panels as described herein generally comprise at least a first rigid substrate, a second rigid substrate, and an asymmetric multilayer acoustic interlayer disposed between and in contact with each of the first and second substrates. The asymmetric multilayer interlayer comprises at least one non-centrally positioned soft (core) layer. Each of the first and second substrates can be formed of a rigid material, such as glass, and may be formed from the same, or from different, materials. In some embodiments, at least one of the first and second substrates can be a glass substrate, while, in other embodiments, at least one of the first and second can be formed of another material including, for example, a rigid polymer such as polycarbonate, copolyesters, acrylic, polyethylene terephthalate, and combinations thereof. In embodiments, both rigid substrates are glass. Any suitable type of non-glass material may be used to form such a substrate, depending on the required performance and properties. Typically, none of the first or second substrates are formed from softer polymeric materials, including thermoplastic polymer materials as described in detail below.

Any suitable type of glass may be used to form the rigid glass substrate, and, in some embodiments, the glass may be selected from the group consisting of alumina-silicate glass, borosilicate glass, quartz or fused silica glass, and soda lime glass. The glass substrate, when used, may be annealed, thermally-strengthened or tempered, chemically-tempered, etched, coated, or strengthened by ion exchange, or it may have been subjected to one or more of these treatments. The glass itself may be rolled glass, float glass, or plate glass. In some embodiments, the glass may not be chemically-treated or strengthened by ion exchange, while, in other embodiments, the glass may not be an alumina-silicate glass. When the first and second substrates are glass substrates, the type of glass used to form each substrate may be the same or it may be different.

The rigid substrates can have any suitable thickness. In some embodiments, when the rigid substrates are all glass substrates, the nominal thickness of at least one of the glass sheets (first or second glass) ranges from 0.1 mm to 12.7 mm and the multiple layer glass panels include the configurations of any combinations of the first and second glass sheets (and any other glass sheets, if desired). In some embodiments, the nominal thickness of the first and/or second substrates can be at least about 0.4, at least about 0.7, at least about 1.0, at least about 1.3, at least about 1.6, at least about 1.9, at least about 2.2, at least about 2.5, or at least about 2.8 or more and/or less than about 3.2, less than about 2.9, less than about 2.6, less than about 2.3, less than about 2.0, less than about 1.7, less than about 1.4, or less than about 1.1 mm. Additionally, or in the alternative, the first and/or second substrates can have a nominal thickness of at least about 2.3, at least about 2.6, at least about 2.9, at least about 3.2, at least about 3.5, at least about 3.8, or at least about 4.1 and/or less than about 12.7, less than about 12, less than about 11.5, less than about 10.5, less than about 10, less than about 9.5, less than about 9, less than about 8.5, less than about 8, less than about 7.5, less than about 7, less than about 6.5, less than about 6, less than about 5.5, less than about 5, or less than about 4.5 mm. Other thicknesses may be appropriate depending on the application and properties required.

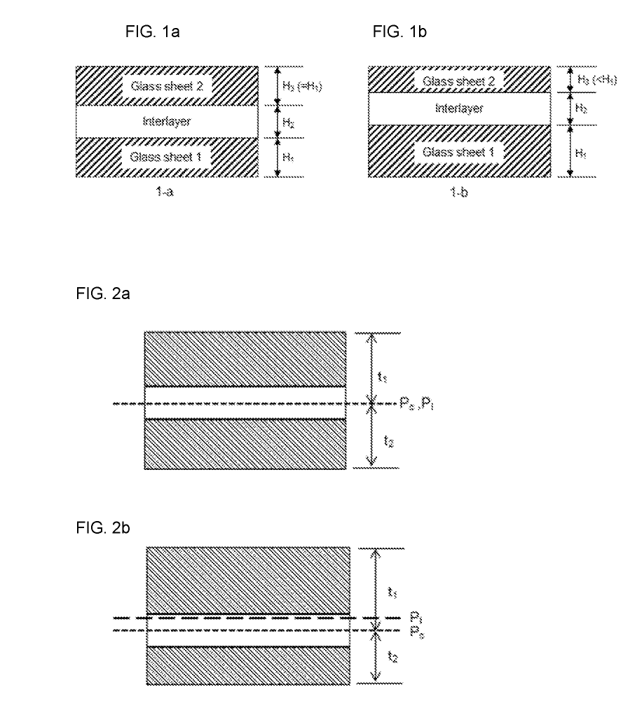

When multiple layer panels include two substrates having the same nominal thickness such panels may be referred to as “symmetric configurations,” as shown in FIG. 1a, because the ratio of the nominal thickness of one substrate to the nominal thickness of the other substrate equals 1. When multiple layer panels include two substrates having the different nominal thicknesses such panels may be referred to as “asymmetric configurations,” as shown in FIG. 1b, because the ratio of the nominal thickness of one substrate to the nominal thickness of the other substrate does not equal 1. As used herein, asymmetric configurations or asymmetric panels are characterized in that the ratio of the thicknesses of the substrates (thinner substrate to thicker substrate) is less than 1.

In embodiments, a multiple layer panel as described herein may include two substrates having different nominal thicknesses, as shown in FIG. 1b. As used herein, the terms “symmetry of substrate” and “symmetry of glass” refer to the ratio of the nominal thickness of the thinner substrate (or glass sheet) to the nominal thickness of the thicker substrate (or glass sheet), and the terms may be used interchangeably. The “symmetry of glass” is determined by equation (1):

Symmetry of Glass (S_{G})=H₃/H₁ (1)

where H₃ is the nominal thickness of the thinner (first) glass substrate, H₁ is the nominal thickness of the thicker (second) glass substrate, and H₃≤H₁. FIG. 1b depicts a cross-section of a panel having an asymmetric configuration.

As used herein, when referring to a multiple layer glass panel the term “symmetrically configured” means having a symmetry of glass, S_{G}, equal to 1, and the term “asymmetrically configured” means having a symmetry of glass of less than 1. The terms “symmetry of glass”, “symmetrically configured”, “symmetrical configuration” and “symmetry of glass configuration” may be used interchangeably throughout. The terms “asymmetrically configured” and “asymmetrical configuration” may be used interchangeably throughout.

In some embodiments, multiple layer panels as described herein can have a symmetry of glass of at least about 0.20, at least about 0.23, at least about 0.25, at least about 0.30, at least about 0.35, at least about 0.40, at least about 0.45, at least about 0.50, at least about 0.55, at least about 0.60, at least about 0.65, at least about 0.70, at least about 0.75 and/or about 1, not more than about 0.99, not more than about 0.97, not more than about 0.95, not more than about 0.90, not more than about 0.85, not more than about 0.80, not more than about 0.75, not more than about 0.70, not more than about 0.65, not more than about 0.60, not more than about 0.55, not more than about 0.50, not more than about 0.45, not more than about 0.40, not more than about 0.35, or not more than about 0.30.

When the multiple layer panel has an asymmetric configuration, the difference between the nominal thickness of the thicker substrate and the nominal thickness of the thinner substrate can be at least about 0.05 mm. In some embodiments, at least one glass sheet has a nominal thickness that can be at least about 0.1, at least about 0.2, at least about 0.3, at least about 0.4, at least about 0.5, at least about 0.6, at least about 0.7, at least about 0.8, at least about 0.9, at least about 1.0, at least about 1.2, at least about 1.6, at least about 2.0, at least about 3.0, or at least about 4.0 mm thicker than the nominal thickness of at least one of the other glass sheets, or of each of the other glass sheets.

The specific glass configuration and thicknesses may be selected depending on the ultimate end use of the multiple layer panel. For example, in some embodiments wherein the multiple layer panel is utilized in automotive applications, the nominal thickness of one substrate can be in the range of from 0.1 to 2.6 mm, from 0.3 to 2.0 mm, or from 0.5 to 1.8 mm, while the nominal thickness of the other substrate can be in the range of from 0.5 to 3.0 mm, from 0.6 to 2.8 mm, from 1.0 to 2.6, or from 1.6 to 2.4 mm, although other ranges may be appropriate. The sum of the thicknesses of the substrates (H₃ +H₁) can be less than 4.6, less than 4.2, less than 4.0, less than 3.7, less than 3.4, or less than 3.2 mm. In embodiments, the ratio of the nominal thicknesses (the symmetry of glass, S_{G}) can be in the range of from 0.20 to less than 1, from 0.23 to 0.95, from 0.25 to 0.80, from 0.30 to 0.70, or from 0.35 to 0.60. Other thicknesses and symmetry of glass values may be used as appropriate, depending on the desired application and performance.

In other embodiments, such as wherein the multiple layer panel is utilized in aeronautical or architectural applications, the nominal thickness of one substrate may be in the range of from 2.2 to 12.7 mm, from 2.6 to 8mm, or from 2.8 to 5 mm, while the nominal thickness of the other substrate may be in the range of from 1.6 to 12.6 mm, from 1.8 to 7.5 mm, or from 2.3 to 5 mm. The sum of the thicknesses of the substrates (H₃ +H₁) in these embodiments can be greater than 4.6 mm, greater than 5.0 mm, greater than 5.5 mm, or greater than 6 mm. In embodiments, the symmetry of glass, S_{G}, can be in the range of from 0.20 to less than 1, from 0.23 to 0.95, from 0.25 to 0.80, from 0.30 to 0.70, or from 0.35 to 0.60. Other thicknesses and symmetry of glass values may be used as appropriate, depending on the desired application and performance.

In addition to the rigid substrates, multiple layer panels as described herein include at least a multilayer polymeric acoustic interlayer disposed between and in contact with each of the first and second rigid substrates. As used herein, the terms “multilayer interlayer”, “multilayer polymer interlayer” and “polymeric multilayer interlayer” refer to a multiple layer polymer sheet suitable for use in forming multiple layer panels. As used herein, the terms “single layer” and “monolithic” refer to interlayers formed of one single polymer layer, while the terms “multiple layer” or “multilayer” refer to interlayers having two or more polymer layers adjacent to and in contact with one another that are coextruded, laminated, or otherwise coupled to one another. Each polymer layer of an interlayer may include one or more polymeric resins, optionally combined with one or more plasticizers, which have been formed into a sheet by any suitable method. One or more of the polymer layers in an interlayer may further include additional additives, although these are not required.

As used herein, the terms “first,” “second,” “third,” and the like are used to describe various elements, but such elements should not be unnecessarily limited by these terms. These terms are only used to distinguish one element from another and do not necessarily imply a specific order or even a specific element. For example, an element may be regarded as a “first” element in the description and a “second” element in the claims without being inconsistent. Consistency is maintained within the description and for each of the independent claims, but such nomenclature is not necessarily intended to be consistent therebetween. Such three-layer (or tri-layer) interlayers may be described as having at least one inner “core” layer sandwiched between two outer “skin” layers.

As used herein, the terms “polymer resin composition” and “resin composition” refer to compositions including one or more polymer resins. Polymer compositions may optionally include other components, such as plasticizers and/or other additives.

In embodiments, the asymmetric multilayer interlayer comprises two stiff layers or skin layers and one soft layer or core layer, and the soft layer is between and in contact with the two stiff layers such that the core layer is non-centrally positioned, as shown in FIG. 2b. Such multiple layer interlayer having a core layer that is non-centrally positioned, is also referred to herein as an “asymmetric interlayer” or “asymmetric core layer”, and is characterized in that the center plane of the core layer (P_{c}) is off the geometry center plane of the multilayer interlayer (Pₗ) and the ratio of the thickness from the center plane of the core layer to the outer surface of the thinner stiff layer (t₂) to the thickness from the center plane of the core layer to the outer surface of the thicker stiff layer (t₁) is less than 1 (see FIG. 2b). This ratio of thicknesses (Sₗ), as used herein, is referred to as the “symmetry of core layer” or “symmetry of interlayer”, and may be shown by equation (2):

Sₗ=t₂/t₁ (2)

where t₂ is the thickness from the center plane of the core layer to the outer surface of thinner stiff layer and t₁ is the thickness from the center plane of the core layer to the outer surface of the thicker stiff layer, and t₂≤t₁. The symmetric multiple layer acoustic interlayer (e.g., the symmetry of core layer equals 1) is characterized in that the center plane of the core layer (P_{c}) is superimposed on the geometry center plane of the multilayer interlayer (Pₗ) and the ratio of the thickness from the center plane of the core layer to one of the outer surfaces of the stiff layers (t₁, t₂) to the thickness from the center plane of the core layer to another outer surface of the stiff layers is 1 (see FIG. 2a). When t₁=t₂, Sₗ=1.

As used herein, the terms “symmetrically configured core layer” and “symmetrically configured interlayer” refer to a multilayer interlayer having a symmetry of core layer (Sₗ) of 1, and the term “symmetry of core layer” and “symmetry of interlayer” may be used interchangeably. When an interlayer contains multiple core (soft) layers, the symmetry of each of the core layers can be calculated as described above.

In embodiments, the center plane of the core layer (P_{c}) can be at any asymmetric position relative to the geometry center plane of the interlayer (Pₗ), as desired. In embodiments of asymmetric multiple layer panels where one substrate is thicker than the other, the center plane of the core layer can be located closer to the thinner substrate (H₃), or the center plane of the core layer can be located closer to the thicker substrate (H₁). In some embodiments, multilayer acoustic interlayer as described herein can have a symmetry of core layer of greater than about 0.01. The range of the symmetry can be from 0.01 to less than 1, from 0.02 to 0.9, from 0.03 to 0.8, from 0.04 to 0.7, and from 0.05 to 0.6. In embodiments, multilayer acoustic interlayers as described herein can have a symmetry of core layer of less than 1, less than 0.90, less than 0.80, less than 0.70, less than 0.60, less than 0.50, less than 0.40, and/or greater than about 0, greater than about 0.05, greater than 0.10, greater than 0.20, or greater than about 0.35 or more.

In embodiments, the asymmetric multilayer acoustic interlayer comprises at least one soft or core layer, while in other embodiments, the asymmetric multilayer acoustic interlayer comprises at least two soft layers, at least three soft layers, at least four soft layers, at least five soft layers, or at least six soft layers or more. In embodiments, an asymmetric multilayer acoustic interlayer comprising more than one soft or core layer, (i.e., two or more soft layers) provides more improvement in sound insulation of an asymmetric glass panel in the coincident frequency region and is therefore more advantageous than an asymmetric multilayer acoustic interlayer comprising only one soft layer.

When the asymmetric multilayer acoustic interlayers comprise two, three, or more soft layers, the soft layers can be the same as or different and may be positioned in the interlayer in different configurations or positions, so long as at least one of the soft layers is asymmetrically configured (the symmetry of core layer is less than 1). For example, the interlayer may comprise at least two soft layers where at least two soft layers are asymmetrically configured, or at least one soft layer is asymmetrically configured and at least one soft layer is symmetrically configured. When there are two or more soft layer that are asymmetrically configured, the symmetry of the core layer can be the same or different.

The overall average thickness of the interlayers according to some embodiments of the present invention can be at least about 10, at least about 15, at least about 20, at least about 25, at least about 30, or at least about 35 mils and/or not more than about 150, not more than about 120, not more than about 90, not more than about 75, not more than about 60, not more than about 50, not more than about 45, not more than about 40, not more than about 35, not more than about 32 mils (1 mil=0.0254 mm). Other thicknesses may be used as desired for a particular application to obtain particular performance properties. If the interlayer is not laminated between two substrates, its average thickness can be determined by directly measuring the thickness of the interlayer using a caliper, or other equivalent device. If the interlayer is laminated between two substrates, its thickness can be determined by subtracting the combined thickness of the substrates from the total thickness of the multiple layer panel.

In some embodiments, one or more polymer layers can have an average thickness at least about 1, at least about 2, at least about 3, at least about 4, at least about 5, at least about 6, at least about 7, at least about 8, at least about 9, or at least about 10 mils or more. Additionally, or in the alternative, one or more of the polymer layers in an interlayer as described herein can have an average thickness of not more than about 25, not more than about 20, not more than about 15, not more than about 12, not more than about 10, not more than about 8, not more than about 6, not more than about 4, or not more than about 2 mils, although other thicknesses may be used as desired.

In some embodiments, the layers or interlayers can comprise flat polymer layers having substantially the same thickness along the length, or longest dimension, and/or width, or second longest dimension, of the sheet, while, in other embodiments, one or more layers of a multilayer interlayer, for example, can be wedge-shaped or can have a wedge-shaped profile, such that the thickness of the interlayer changes along the length and/or width of the sheet, such that one edge of the layer or interlayer has a thickness greater than the other. When the interlayer is a multilayer interlayer, at least one, at least two, or at least three or more of the layers of the interlayer can be wedge-shaped. Wedge-shaped interlayers may be useful in, for example, heads-up-display (HUD) panels in automotive and aircraft applications.

Examples of suitable thermoplastic polymers can include, but are not limited to, poly(vinyl acetal) resins, polyurethanes (PU), poly(ethylene-co-vinyl acetate) resins (EVA), polyvinyl chlorides (PVC), poly(vinylchloride-co-methacrylate), polyethylenes, polyolefins, ethylene acrylate ester copolymers, poly(ethylene-co-butyl acrylate), silicone elastomers, epoxy resins, and acid copolymers such as ethylene/carboxylic acid copolymers and ionomers thereof, derived from any of the previously-listed polymers, and combinations thereof. In some embodiments, one or more layers of a multiple layer interlayer can include a thermoplastic polymer which can be selected from the group consisting of poly(vinyl acetal) resins, polyvinyl chlorides, polyethylene vinyl acetates, and polyurethanes. In certain embodiments, one or more of the polymer layers can include at least one poly(vinyl acetal) resin. Although generally described herein with respect to poly(vinyl acetal) resins, it should be understood that one or more of the above polymer resins could be included with, or in place of, the poly(vinyl acetal) resins described below in accordance with various embodiments of the present invention.

Polyurethanes suitable for use in the layers and interlayers can have different hardnesses. An exemplary polyurethane polymer has a Shore A hardness less than 85 per ASTM D-2240. Examples of polyurethane polymers are AG8451 and AG5050, aliphatic isocyanate polyether based polyurethanes having glass transition temperatures less than 20° C. (commercially available from Thermedics Inc. of Woburn, Mass.). EVA polymers can contain various amounts of vinyl acetate groups. The desirable vinyl acetate content is generally from about 10 to about 90 mol %. EVA with lower vinyl acetate content can be used for sound insulation at low temperatures. When included, the ethylene/carboxylic acid copolymers are generally poly(ethylene-co-methacrylic acid) and poly(ethylene-co-acrylic acid) with a carboxylic acid content of from about 1 to about 25 mol %. lonomers of ethylene/carboxylic acid copolymers can be obtained by partially or fully neutralizing the copolymers with a base, such as the hydroxide of alkali (sodium for example) and alkaline metals (magnesium for example), ammonia, or other hydroxides of transition metals such as zinc. Examples of ionomers that are suitable include Surlyn® ionomers resins (commercially available from DuPont of Wilmington, Del.).

Multiple layer interlayers used in the glass panels of the invention include any interlayer having at least two layers, or at least three layers, and having acoustic properties, such as multiple layer acoustic interlayers comprising at least a first stiff layer, a second stiff layer, and a third soft layer disposed between the first and second stiff layers. Additional numbers of layers and interlayer combinations are possible, such as, soft/stiff/soft, soft/stiff/soft/stiff/soft, stiff/soft/stiff/soft/stiff, stiff/soft/soft/stiff, and other embodiments known to one skilled in the art.

Multilayer acoustic interlayers suitable for use in multiple layer glass panels of the present invention include interlayers comprising a soft layer with one or more physical characteristics modified in order to increase the acoustic dampening property and reduce the sound transmission through the glass and stiff outer layers, usually skin layers, providing handling, processability, and mechanical strength of the interlayer. As used herein, “stiff layer” or “stiffer layer” generally refers to a layer that is stiffer or more rigid than another layer and that has a glass transition temperature that is generally at least two (2) degrees C. higher than another layer. As used herein, the “soft layer” or “softer layer” generally refers to a layer that is softer than another layer and that has a glass transition temperature that is generally at least two (2) degrees C. lower than another layer. One of the unique physical characteristics that is modified in order to achieve the improved sound insulation property is the lower glass transition temperature of the soft (core) layer. In embodiments, a suitable glass transition temperature of the soft layer is less than about 25, less than about 20, less than about 15, less than about 10, less than about 5, less than about 0, or less than about −5° C. In addition to the lower glass transition temperature of the soft layer, the multilayer acoustic interlayers suitable for use in multiple layer glass panels of the present invention may include interlayers have damping loss factors at 20° C. of at least 0.10, at least about 0.15, at least about 0.20 or more.

For multilayer glass panels, damping loss factor can be correlated generally with sound transmission loss at the coincident frequency, and as damping loss factor increases, sound transmission loss at the coincident frequency increases (see, for example, Lu, J: “Designing PVB Interlayer for Laminated Glass with Enhanced Sound Reduction”, 2002, InterNoise 2002, paper 581; Lu, J. “Windshields with New PVB Interlayer for Vehicle Interior Noise Reduction and Sound Quality Improvement” 2003 SAE Noise & Vibration Conference, Traverse City, Mich., May 5-9, 2003, Society of Automotive Engineers Paper No. 2003-01-1587).

Examples of exemplary multilayer interlayer constructs include, but are not limited to, PVB//PVB//PVB, PVnB//PViB//PVnB, where the PVB (poly(vinyl butyral), PVnB (polyvinyl n-butyral) and/or PViB (poly(vinyl ibutyral) layer comprises a single resin or two or more resins having different residual hydroxyl contents or different polymer compositions; PVC//PVB//PVC, PVB//PVC//PVB, PVB//PU//PVB, PU//PVB//PU, lonomer//PVB//lonomer, lonomer//PU//lonomer, lonomer//EVA//lonomer, lonomer//lonomer//lonomer, where the soft core layer (PVB (including PViB), PVC, PU, EVA or ionomer) comprises a single resin or two or more resins having different glass transition temperatures. Alternatively, the skin and core layers may all be PVB using the same or different starting resins. Other combinations of resins and polymers will be apparent to those skilled in the art. In general, as used herein “PVB” and “PVB resin” refer to PVnB or PViB or combinations of PVnB and PViB unless otherwise stated.

The soft core layer in a multilayer interlayer can contain one or more resins. When the core layer comprises at least one polyvinyl acetal resin, the resin, or at least one resin, in the soft core layer has at least one of the following characteristics: lower residual hydroxyl; higher residual vinyl acetate content; lower residual hydroxyl content and higher residual acetate content; different aldehyde from the stiff layers; mixed aldehydes; or a combination of any two or more properties. The soft layer typically contains at least one plasticizer, and in some embodiments, a mixture of two or more plasticizers, and in typical embodiments, the soft layer has a higher plasticizer content than the stiffer layer(s). Any combination of layer and interlayer properties may be used as desired and known to one of skill in the art.

Conventional asymmetric laminated glass panels containing a symmetric multilayer acoustic interlayer (i.e., the symmetry of core layer is 1) have sound insulation as measured by sound transmission loss (STL) at the coincident frequency that is essentially independent of the combined glass thickness and have lower sound insulation in the coincident frequency region than the conventional symmetric laminated glass panel containing the same symmetric multilayer acoustic interlayer. In general, the sound insulation of a conventional asymmetric multilayer glass panel in the coincident frequency region decreases as the symmetry of glass, S_{G}, is decreased or reduced. In one conventional asymmetric multilayer glass panel configuration (1.6 mm/0.7 mm, symmetry of glass=0.44, combined glass thickness=2.3 mm) having an acoustic interlayer having the symmetry of core layer of 1, the sound insulation is reduced by as much as 1.5 to 1.7 dB when compared with conventional symmetric multilayer glass panels (0.7 mm/0.7 mm, 1.85 mm/1.85 mm, 2.1 mm/2.1 mm, and 2.3 mm/2.3 mm configurations having combined glass thicknesses of 1.4, 3.7, 4.2 and 4.6 mm respectively) having the same symmetric multilayer acoustic interlayer (symmetry of core layer of 1) as in the asymmetric multilayer glass panel. In another conventional asymmetric glass panel configuration of 3.0 mm/0.7 mm (symmetry of glass=0.23, combined glass thickness=3.7 mm) having a symmetric acoustic interlayer (symmetry of core layer of 1), the sound insulation is reduced by as much as 4.1 to 4.3 dB when compared with the conventional symmetric multilayer glass panels having the same symmetric multilayer acoustic interlayer (symmetry of core layer is 1) as in the asymmetric multilayer glass panel.

Thermoplastic polymer resins may be formed by any suitable method. When the thermoplastic polymer resins include poly(vinyl acetal) resins, such resins may be formed by acetalization of poly(vinyl alcohol) with one or more aldehydes in the presence of a catalyst according to known methods such as, for example, those described in U.S. Pat. Nos. 2,282,057 and 2,282,026, as well as “Vinyl Acetal Polymers,” in the Encyclopedia of Polymer Science & Technology, 3^{rd} ed., Volume 8, pages 381-399, by B. E. Wade (2003). The resulting poly(vinyl acetal) resins may include at least about 50, at least about 60, at least about 70, at least about 75, at least about 80, at least about 85, at least about 90 weight percent of residues of at least one aldehyde, measured according to ASTM D1396 as the percent acetalization of the resin. The total amount of aldehyde residues in a poly(vinyl acetal) resin can be collectively referred to as the acetal content, with the balance of the poly(vinyl acetal) resin being residual hydroxyl groups (as vinyl hydroxyl groups) and residual ester groups (as vinyl acetate groups), as discussed in further detail below.

Suitable poly(vinyl acetal) resins may include residues of any aldehyde and, in some embodiments, may include residues of at least one C₄ to C₈ aldehyde. Examples of suitable C₄ to C₈ aldehydes can include, for example, n-butyraldehyde, i-butyraldehyde, 2-methylvaleraldehyde, n-hexyl aldehyde, 2-ethylhexyl aldehyde, n-octyl aldehyde, and combinations thereof. One or more of the poly(vinyl acetal) resins utilized in the layers and interlayers described herein can include at least about 5, at least about 10, at least about 20, at least about 30, at least about 40, at least about 50, at least about 60, or at least about 70 weight percent of residues of at least one C₄ to C₈ aldehyde, based on the total weight of aldehyde residues of the resin. Alternatively, or in addition, the poly(vinyl acetal) resin may include not more than about 95, not more than about 90, not more than about 85, not more than about 80, not more than about 75, not more than about 70, or not more than about 65 weight percent of at least one C₄ to C₈ aldehyde. The C₄ to C₈ aldehyde may be selected from the group listed above, or it can be selected from the group consisting of n-butyraldehyde, i-butyraldehyde, 2-ethylhexyl aldehyde, and combinations thereof. In other embodiments, the poly(vinyl acetal) resin may comprise residues of other aldehydes, including, but not limited to, cinnamaldehyde, hexylcinnamaldehyde, benzaldehyde, hydrocinnamaldehyde, 4-chlorobenzaldehyde, 4-t-butylphenylacetaldehyde, propionaldehyde, 2-phenylpropionaldehyde, and combinations thereof, alone or in combination with one or more of the C₄ to C₈ aldehydes described herein.

In various embodiments, the poly(vinyl acetal) resin may be a PVB resin that primarily comprises residues of n-butyraldehyde, and may, for example, include any desired amount of residues of an aldehyde other than n-butyraldehyde. Typically, the aldehyde residues other than n-butyraldehyde present in poly(vinyl butyral) resins may include i-butyraldehyde, 2-ethylhexyl aldehyde, and combinations thereof. When the poly(vinyl acetal) resin comprises a poly(vinyl butyral) resin, the weight average molecular weight of the resin can be at least about 30,000, at least about 50,000, at least about 80,000, at least about 100,000, at least about 130,000, at least about 150,000, at least about 175,000, at least about 200,000, at least about 300,000, or at least about 400,000 Daltons, measured by size exclusion chromatography using low angle laser light scattering (SEC/LALLS) method of Cotts and Ouano.

As previously described, poly(vinyl acetal) resins can be produced by hydrolyzing a poly(vinyl acetate) to poly(vinyl alcohol), and then acetalizing the poly(vinyl alcohol) with one or more of the above aldehydes to form a poly(vinyl acetal) resin. In the process of hydrolyzing the poly(vinyl acetate), not all the acetate groups are converted to hydroxyl groups, and, as a result, residual acetate groups remain on the resin. Similarly, in the process of acetalizing the poly(vinyl alcohol), not all of the hydroxyl groups are converted to acetal groups, which also leaves residual hydroxyl groups on the resin. As a result, most poly(vinyl acetal) resins include both residual hydroxyl groups (as vinyl hydroxyl groups) and residual acetate groups (as vinyl acetate groups) as part of the polymer chain. As used herein, the terms “residual hydroxyl content” and “residual acetate content” refer to the amount of hydroxyl and acetate groups, respectively, that remain on a resin after processing is complete. Both the residual hydroxyl content and the residual acetate content are expressed in weight percent, based on the weight of the polymer resin, and are measured according to ASTM D1396.

The poly(vinyl acetal) resins utilized in one or more polymer layers as described herein may have a residual hydroxyl content of at least about 6, at least about 7, at least about 8, at least about 9, at least about 10, at least about 11, at least about 12, at least about 13, at least about 14, at least about 15, at least about 16, at least about 17, at least about 18, at least about 18.5, at least about 19, at least about 20, at least about 21, at least about 22, at least about 23, at least about 24, at least about 25, at least about 26, at least about 27, at least about 28, at least about 29, at least about 30, at least about 31, at least about 32, or at least about 33 weight percent or more. Additionally, or in the alternative, the poly(vinyl acetal) resin or resins utilized in polymer layers of the present invention may have a residual hydroxyl content of not more than about 45, not more than about 43, not more than about 40, not more than about 37, not more than about 35, not more than about 34, not more than about 33, not more than about 32, not more than about 31, not more than about 30, not more than about 29, not more than about 28, not more than about 27, not more than about 26, not more than about 25, not more than about 24, not more than about 23, not more than about 22, not more than about 21, not more than about 20, not more than about 19, not more than about 18.5, not more than about 18, not more than about 17, not more than about 16, not more than about 15, not more than about 14, not more than about 13, not more than about 12, not more than about 11, or not more than about 10 weight percent.

In some embodiments, one or more polymer layers can include at least one poly(vinyl acetal) resin having a residual hydroxyl content of at least about 20, at least about 21, at least about 22, at least about 23, at least about 24, at least about 25, at least about 26, at least about 27, at least about 28, at least about 29, or at least about 30 weight percent and/or not more than about 45, not more than about 43, not more than about 40, not more than about 37, not more than about 35, not more than about 34, not more than about 33, or not more than about 32 weight percent. In some embodiments, one or more polymer layers can include at least one poly(vinyl acetal) resin having a residual hydroxyl content of at least about 6, at least about 7, at least about 8, at least about 9, at least about 10, at least about 11, or at least about 12 and/or not more than about 17, not more than about 16, not more than about 15, or not more than about 14 weight percent. When a polymer layer or interlayer includes more than one type of poly(vinyl acetal) resin, each of the poly(vinyl acetal) resins may have substantially the same residual hydroxyl contents, or one or more of the poly(vinyl acetal) resins may have a residual hydroxyl content substantially different from one or more other poly(vinyl acetal) resins.

One or more poly(vinyl acetal) resins used in interlayers according to the present invention may have a residual acetate content of not more than about 30, not more than about 25, not more than about 20, not more than about 18, not more than about 15, not more than about 12, not more than about 10, not more than about 8, not more than about 6, not more than about 4, not more than about 3, or not more than about 2 weight percent. Alternatively, or in addition, at least one poly(vinyl acetal) resin used in a polymer layer or interlayer as described herein can have a residual acetate content of at least about 3, at least about 4, at least about 5, at least about 6, at least about 7, at least about 8, at least about 9, at least about 10, at least about 12, or at least about 14 weight percent or more. When a polymer layer or interlayer includes two or more poly(vinyl acetal) resins, the resins may have substantially the same residual acetate content, or one or more resins may have a residual acetate content different from the residual acetate content of one or more other poly(vinyl acetal) resins.

The polymeric resin or resins utilized in polymer layers and multilayer acoustic interlayers as described herein may comprise one or more thermoplastic polymer resins. In some embodiments, the thermoplastic resin or resins may be present in the polymer layer in an amount of at least about 45, at least about 50, at least about 55, at least about 60, at least about 65, at least about 70, at least about 75, at least about 80, at least about 85, at least about 90, or at least about 95 weight percent, based on the total weight of the resins in the polymer layer. When two or more resins are present, each may be present in an amount of at least about 0.5, at least about 1, at least about 2, at least about 5, at least about 10, at least about 15, at least about 20, at least about 25, at least about 30, at least about 35, at least about 40, at least about 45, or at least about 50 weight percent, based on the total weight of the resins in the polymer layer or interlayer.

One or more polymer layers as described herein may also include at least one plasticizer. When present, the plasticizer content of one or more polymer layers can be at least about 2, at least about 5, at least about 6, at least about 8, at least about 10, at least about 15, at least about 20, at least about 25, at least about 30, at least about 35, at least about 40, at least about 45, at least about 50, at least about 55, at least about 60, at least about 65, at least about 70, at least about 75, or at least about 80 parts per hundred resin (phr) and/or not more than about 120, not more than about 110, not more than about 105, not more than about 100, not more than about 95, not more than about 90, not more than about 85, not more than about 75, not more than about 70, not more than about 65, not more than about 60, not more than about 55, not more than about 50, not more than about 45, not more than about 40, or not more than about 35 phr. In some embodiments, one or more polymer layers can have a plasticizer content of not more than 35, not more than about 32, not more than about 30, not more than about 27, not more than about 26, not more than about 25, not more than about 24, not more than about 23, not more than about 22, not more than about 21, not more than about 20, not more than about 19, not more than about 18, not more than about 17, not more than about 16, not more than about 15, not more than about 14, not more than about 13, not more than about 12, not more than about 11, or not more than about 10 phr.

As used herein, the term “parts per hundred resin” or “phr” refers to the amount of plasticizer present per one hundred parts of resin, on a weight basis. For example, if 30 grams of plasticizer were added to 100 grams of a resin, the plasticizer content would be 30 phr. If the polymer layer includes two or more resins, the weight of plasticizer is compared to the combined amount of all resins present to determine the parts per hundred resin. Further, when the plasticizer content of a layer or interlayer is provided herein, it is provided with reference to the amount of plasticizer in the mix or melt that was used to produce the layer or interlayer, unless otherwise specified.

For layers of unknown plasticizer content, the plasticizer content can be determined via a wet chemical method in which an appropriate solvent, or mixture of solvents, is used to extract the plasticizer from the polymer layer or interlayer. Prior to extracting the plasticizer, the weight of the sample layer is measured and compared with the weight of the layer from which the plasticizer has been removed after extraction. Based on this difference, the weight of plasticizer can be determined and the plasticizer content, in phr, calculated. For multiple layer interlayers, the polymer layers can be physically separated from one another and individually analyzed according to the above procedure.

Although not wishing to be bound by theory, it is understood that, for a given type of plasticizer, the compatibility of the plasticizer in the poly(vinyl acetal) resin may be correlated to the residual hydroxyl content of the resin. More particularly, poly(vinyl acetal) resins having higher residual hydroxyl contents may generally have a reduced plasticizer compatibility or capacity, while poly(vinyl acetal) resins with a lower residual hydroxyl content may exhibit an increased plasticizer compatibility or capacity. Generally, this correlation between the residual hydroxyl content of a polymer and its plasticizer compatibility/capacity can be manipulated in order to facilitate addition of the proper amount of plasticizer to the polymer resin and to stably maintain differences in plasticizer content between multiple layers within an interlayer. Similar correlation may also exist for the compatibility of the plasticizer and residual acetate content in the poly(vinyl acetal) resin.

Any suitable plasticizer can be used in the polymer layers described herein. The plasticizer may have a hydrocarbon segment of at least about 6 and/or not more than about 30, not more than about 25, not more than about 20, not more than about 15, not more than about 12, or not more than about 10 carbon atoms. In various embodiments, the plasticizer is selected from conventional plasticizers or a mixture of two or more conventional plasticizers. In some embodiments, the conventional plasticizer, which generally has refractive index of less than about 1.450, may include, triethylene glycol di-(2-ethylhexanoate) (“3GEH”), triethylene glycol di-(2-ethylbutyrate), tetraethylene glycol di-(2-ethylhexanoate) (“4GEH”), triethylene glycol diheptanoate, tetraethylene glycol diheptanoate, dihexyl adipate, dioctyl adipate, hexyl cyclohexyladipate, diisononyl adipate, heptylnonyl adipate, di(butoxyethyl) adipate, bis(2-(2-butoxyethoxy)ethyl) adipate, dibutyl sebacate, dioctyl sebacate, butyl ricinoleate, castor oil, triethyl glycol ester of coconut oil fatty acids, and oil modified sebacic alkyd resins. In some embodiments, the conventional plasticizer is 3GEH (Refractive index=1.442 at 25° C.).

In some embodiments, other plasticizers known to one skilled in the art may be used, such as a plasticizer with a higher refractive index (i.e., a high refractive index plasticizer). As used herein, a “high refractive index plasticizer” is a plasticizer having a refractive index of at least about 1.460. As used herein, the refractive index (also known as index of refraction) of a plasticizer or a resin is either measured in accordance with ASTM D542 at a wavelength of 589 nm and 25° C. or is reported in literature in accordance with ASTM D542. In various embodiments, the refractive index of the plasticizer is at least about 1.460, or greater than about 1.470, or greater than about 1.480, or greater than about 1.490, or greater than about 1.500, or greater than 1.510, or greater than 1.520, for both core and skin layers. In some embodiments, the high refractive index plasticizer(s) is used in conjunction with a conventional plasticizer(s), and in some embodiments, if included, the conventional plasticizer is 3GEH, and the refractive index of the plasticizer mixture is at least 1.460. Examples of suitable high refractive index plasticizers include, but are not limited to, dipropylene glycol dibenzoate, tripropylene glycol dibenzoate, polypropylene glycol dibenzoate, isodecyl benzoate, 2-ethylhexyl benzoate, diethylene glycol benzoate, butoxyethyl benzoate, butoxyethyoxyethyl benzoate, butoxyethoxyethoxyethyl benzoate, propylene glycol dibenzoate, 2,2,4-trimethyl-1,3-pentanediol dibenzoate, 2,2,4-trimethyl-1,3-pentanediol benzoate isobutyrate, 1,3-butanediol dibenzoate, diethylene glycol di-o-toluate, triethylene glycol di-o-toluate, dipropylene glycol di-o-toluate, 1,2-octyl dibenzoate, tri-2-ethylhexyl trimellitate, di-2-ethylhexyl terephthalate, bis-phenol A bis(2-ethylhexaonate), di-(butoxyethyl) terephthalate, di-(butoxyethyoxyethyl) terephthalate, dibutoxy ethyl phthalate, diethyl phthalate, dibutyl phthalate, trioctyl phosphate, phenyl ethers of polyethylene oxide rosin derivatives, and tricresyl phosphate, and mixtures thereof. In some embodiments, the plasticizer may comprise, or consist of, a mixture of conventional and high refractive index plasticizers.

Additionally, at least one polymer layer may also include other types of additives that can impart particular properties or features to the polymer layer or interlayer. Such additives can include, but are not limited to, adhesion control agents (“ACAs”), dyes, pigments, stabilizers such as ultraviolet (“UV”) stabilizers, antioxidants, anti-blocking agents, flame retardants, IR absorbers or blockers (such as indium tin oxide, antimony tin oxide, lanthanum hexaboride (LaB₆) and cesium tungsten oxide), processing aides, flow enhancing additives, lubricants, impact modifiers, nucleating agents, thermal stabilizers, UV absorbers, dispersants, surfactants, chelating agents, coupling agents, adhesives, primers, reinforcement additives, fillers, and refractive index (RI) balancing agent(s). As used herein, the term “refractive index balancing agent” or “RI balancing agent” refers to any component or additive included in the composition, layer, or interlayer for adjusting the refractive index of at least one of the resins or layers. Specific types and amounts of such additives may be selected based on the final properties or end use of a particular interlayer.

Depending on the polymer type and layer composition, the polymer layers described herein may exhibit a wide range of glass transition temperatures. In some embodiments, multilayer acoustic interlayers including two or more polymers or polymer layers can exhibit two or more glass transition temperatures. The glass transition temperature (T_{g}) of a polymeric material is the temperature that marks the transition of the material from a glassy state to a rubbery state. The glass transition temperatures of the polymer layers described herein were determined by dynamic mechanical thermal analysis (DMTA) according to the following procedure. A polymer sheet is molded into a sample disc of 25 millimeters (mm) in diameter. The polymer sample disc is placed between two 25-mm diameter parallel plate test fixtures of a Rheometrics Dynamic Spectrometer II. The polymer sample disc is tested in shear mode at an oscillation frequency of 1 Hertz as the temperature of the sample is increased from -20 to 70° C. or other temperature ranges at a rate of 2° C/minute. The position of the maximum value of tan delta (G″/G′) plotted as dependent on temperature is used to determine the glass transition temperature. Experience indicates that the method is reproducible to within +/−1° C.

Multilayer acoustic interlayers as described herein may include at least one polymer layer having a glass transition temperature of at least about −20, at least about −10, at least about −5, at least about −1, at least about 0, at least about 1, at least about 2, at least about 5, at least about 10, at least about 15, at least about 20, at least about 25, at least about 27, at least about 30, at least about 32, at least about 33, at least about 34, at least about 35, at least about 36, at least about 37, at least about 38, or at least about 40° C. Alternatively, or in addition, a polymer layer can have a glass transition temperature of not more than about 25, not more than about 20, not more than about 15, not more than about 10, not more than about 5, not more than about 2, not more than about 0, not more than about −1, or not more than about -5° C.

In some embodiments, one or more polymer layers may have a glass transition temperature of at least about 30, at least about 32, at least about 33, at least about 35, at least about 36, at least about 37, at least about 38, at least about 39° C., or at least about 40° C. and/or not more than about 100, not more than about 90, not more than about 80, not more than about 70, not more than about 60, not more than about 50, not more than about 45, not more than about 44, not more than about 43, not more than about 42, not more than about 41, not more than about 40, not more than about 39, not more than about 38, or not more than about 37° C. Alternatively, or in addition, at least one polymer layer may have a glass transition temperature of at least about −10, at least about −5, at least about −2, at least about −1, at least about 0, at least about 1, at least about 2, at least about 5 and/or not more than about 25, not more than about 20, not more than about 15, not more than about 10, not more than about 5, not more than about 2, not more than about 1, not more than about 0, or not more than about −1° C. When a multilayer acoustic interlayer includes two or more polymer layers, at least one of the layers may have a glass transition temperature different from one or more other polymer layers within the interlayer. Stated differently, when there are two or more layers, each layer may have a different glass transition temperature. In embodiments, one or more layers have a glass transition temperature of less than about 25° C.

In some embodiments, a polymer layer according to the present invention may have a tan delta value at glass transition temperature of at least about 0.50, at least about 0.60, at least about 0.70, at least about 0.80, at least about 0.90, at least about 1.00, at least about 1.10, at least about 1.25, at least about 1.50, at least about 1.75, at least about 2.00, or at least about 2.25, as measured by DMTA.

In some embodiments, each of the polymer layers in an interlayer includes a poly(vinyl acetal) resin. In other embodiments, the multilayer acoustic interlayer may include at least a first polymer layer comprising a first poly(vinyl acetal) resin and a second poly(vinyl acetal) layer comprising a second poly(vinyl acetal) resin. The first and second polymer layers can be adjacent to one another or, optionally, may have one or more intervening polymer layers therebetween.

When present, the first and second (or more) poly(vinyl acetal) resins of respective first and second polymer layers can have different compositions. For example, in some embodiments, the first poly(vinyl acetal) resin can have a residual hydroxyl content that is at least about 2, at least about 3, at least about 4, at least about 5, at least about 6, at least about 7, at least about 8, at least about 9, at least about 10, at least about 12, at least about 13, at least about 14, at least about 15, at least about 16, at least about 17, at least about 18, at least about 19, at least about 20, at least about 21, at least about 22, at least about 23, or at least about 24 weight percent different than the residual hydroxyl content of the second poly(vinyl acetal) resin.

Additionally, or in the alternative, the first poly(vinyl acetal) resin can have a residual acetate content that is at least about 2, at least about 3, at least about 4, at least about 5, at least about 6, at least about 7, at least about 8, at least about 9, at least about 10, at least about 12, at least about 13, at least about 15, at least about 18, or at least about 20 weight percent different than the residual acetate content of the second poly(vinyl acetal) resin. In other embodiments, the first poly(vinyl acetal) resin can have a residual acetate content that is not more than about 2, not more than about 1.5, not more than about 1, or not more than about 0.5 weight percent different than the residual acetate content of the second poly(vinyl acetal) resin.

As used herein, the term “weight percent different” or “the difference . . . is at least . . . weight percent” refers to a difference between two given percentages, calculated by finding the absolute value of the mathematical difference between the two numbers. A value that is “different” from a given value can be higher or lower than the given value. For example, a first poly(vinyl acetal) resin having a residual hydroxyl content that is “at least 2 weight percent different than” the residual hydroxyl content of a second poly(vinyl acetal) resin may have a residual hydroxyl content that is at least 2 weight percent higher or at least 2 weight percent lower than the second residual hydroxyl content. For example, if the residual hydroxyl content of the exemplary second poly(vinyl acetal) resin is 14 weight percent, the residual hydroxyl content of the exemplary first poly(vinyl acetal) resin can be at least 16 weight percent (e.g., at least 2 weight percent higher) or not more than 12 weight percent (e.g., at least 2 weight percent lower).

As a result of having different compositions, the portions of the layer or interlayer formed from the different resins, such as the first poly(vinyl acetal) resin and the second poly(vinyl acetal) resin may have different properties, due to, for example, differences in plasticizer content. As described previously, when two poly(vinyl acetal) resins having different residual hydroxyl contents are blended with a plasticizer, the plasticizer will partition between the different resins, such that a higher amount of plasticizer is present in the layer(s) formed from the lower residual hydroxyl content resin and less plasticizer is present in the portion of the layer(s) including the higher residual hydroxyl content resin. Ultimately, a state of equilibrium is achieved between the two resins. The correlation between the residual hydroxyl content of a poly(vinyl acetal) resin and plasticizer compatibility/capacity can facilitate addition of a proper amount of plasticizer to the polymer resin. Such a correlation also helps to stably maintain the difference in plasticizer content between two or more layers when the plasticizer would otherwise migrate from one layer to the other layer.

When the first and second poly(vinyl acetal) resins have different residual hydroxyl contents and/or have different residual acetate contents, the first and second polymer layers may also include different amounts of plasticizer. As a result, each of these portions may also exhibit different properties, such as, for example, glass transition temperature. In some embodiments, the difference in plasticizer content between adjacent polymer layers can be at least about 2, at least about 5, at least about 8, at least about 10, at least about 12, or at least about 15 phr, measured as described above. In other embodiments, the difference in plasticizer content between adjacent polymer layers can be at least about 18, at least about 20, at least about 25, at least about 30, at least about 35, at least about 40, at least about 45, at least about 50, at least about 55, at least about 60, or at least about 65 phr.

In addition, or in the alternative, the difference between the plasticizer content of adjacent polymer layers may be not more than about 40, not more than about 35, not more than about 30, not more than about 25, not more than about 20, not more than about 17, not more than about 15 or not more than about 12 phr. The values for the plasticizer content of each of the first and second polymer layers may fall within one or more of the ranges provided above.

In some embodiments, the glass transition temperature of the first polymer layer can be at least about 3, at least about 5, at least about 8, at least about 10, at least about 12, at least about 13, at least about 15, at least about 18, at least about 20, at least about 22, at least about 25, at least about 30, at least about 35, or at least about 40° C. different than the glass transition temperature of the second polymer layer. The values for the glass transition temperatures of each of the first and second polymer layers may fall within one or more of the ranges provided above.

When the multiple layer interlayer includes three or more polymer layers, each of the respective first, second, and third (or more) polymer layers can include at least one poly(vinyl acetal) resin and an optional plasticizer(s) of the types and in the amounts described in detail previously. According to some embodiments, the second (inner) polymer layer can include a resin having a residual hydroxyl content lower than the residual hydroxyl contents of the poly(vinyl acetal) resins in each of the first and third (outer) polymer layers. Consequently, as the plasticizer partitions between the layers, the inner layer may have a glass transition temperature lower than the glass transition temperature of each of the outer polymer layers. Although not wishing to be bound by theory, it is understood that this type of configuration, wherein relatively “stiff” (i.e., higher glass transition temperature) outer polymer layers are sandwiching a “soft” (i.e., relatively low glass transition temperature) inner layer, may facilitate enhanced acoustic performance from the interlayer. Alternatively, in other embodiments, the stiff layer is present as an inner layer and sandwiched by two soft outer layers, creating a multilayer interlayer of soft/stiff/soft configuration. Other embodiments having additional layers and/or configurations are also possible, such as interlayers having four, five, six, seven or more layers.

In some embodiments, two (or more) layers, such as the outer polymer layers, can have the same or similar compositions and/or properties. For example, in some embodiments, the poly(vinyl acetal) resin in the first polymer layer can have a residual hydroxyl content within about 2, within about 1, or within about 0.5 weight percent of the residual hydroxyl content of the poly(vinyl acetal) resin in the third polymer layer. Similarly, the poly(vinyl acetal) resins in the first and third layer can have residual acetate contents within about 2, within about 1, or within about 0.5 weight percent of one another. Additionally, the first and third outer polymer layers may have the same or similar plasticizer contents and/or may exhibit the same or similar glass transition temperatures. For example, the plasticizer content of the first polymer layer can be less than 2, not more than about 1, or not more than about 0.5 phr different than the plasticizer content of the third polymer layer, and/or the first and third polymer layers can have glass transition temperatures that differ by less than 2, not more than about 1, or not more than about 0.5° C.

In various embodiments, the differences in residual hydroxyl and/or residual acetate content of the first and second poly(vinyl acetal) resins can be selected to control or provide certain performance properties, such as strength, impact resistance, penetration resistance, processability, or acoustic performance to the final composition, layer, or interlayer. For example, poly(vinyl acetal) resins having a higher residual hydroxyl content, usually greater than about 17 weight percent, can facilitate high impact resistance, penetration resistance, and strength to a resin composition or layer, while lower hydroxyl content resins, usually having a residual hydroxyl content of less than 17 weight percent, can improve the acoustic performance of the interlayer.

The interlayers of the present invention can be formed according to any suitable method. Exemplary methods can include, but are not limited to, solution casting, compression molding, injection molding, melt extrusion, melt blowing, and combinations thereof. Multilayer interlayers including two or more polymer layers may also be produced according to any suitable method such as, for example, co-extrusion, blown film, melt blowing, dip coating, solution coating, blade, paddle, air-knife, printing, powder coating, spray coating, lamination, and combinations thereof.

According to various embodiments of the present invention, the layers or interlayers may be formed by extrusion or co-extrusion. In an extrusion process, one or more thermoplastic resins, plasticizers, and, optionally, one or more additives as described previously, can be pre-mixed and fed into an extrusion device(s). The extrusion device(s) is configured to impart a particular profile shape to the thermoplastic composition in order to create an extruded sheet. The extruded sheet, which is at an elevated temperature and highly viscous throughout, can then be cooled to form a polymeric sheet. Once the sheet has been cooled and set, it may be cut and rolled for subsequent storage, transportation, and/or use as an interlayer.

Co-extrusion is a process by which multiple layers of polymer material are extruded simultaneously. Generally, this type of extrusion utilizes two or more extruders to melt and deliver a steady volume throughput of different thermoplastic melts of different viscosities or other properties through a co-extrusion die into the desired final form. The thickness of the multiple polymer layers leaving the extrusion die in the co-extrusion process can generally be controlled by adjustment of the relative speeds of the melt through the extrusion die and by the sizes of the individual extruders processing each molten thermoplastic resin material.

According to some embodiments, multiple layer panels of the present invention exhibit desirable acoustic properties, as indicated by, for example, the reduction in the transmission of sound as it passes through (i.e., the sound transmission loss of) the interlayer. In some embodiments, multiple layer panels of the present invention may exhibit a sound transmission loss at the coincident frequency, measured according to ASTM E90 at 20° C. and panel dimensions of 50 cm by 80 cm, of at least about 34, at least about 35, at least about 36, at least about 37, at least about 38, at least about 39, at least about 40, at least about 41, or at least about 42 dB or more.

Additionally, the layers and interlayers can have a damping loss factor, or loss factor, of at least about 0.10, at least about 0.12, at least about 0.15, at least about 0.17, at least about 0.20, at least about 0.25, at least about 0.27, at least about 0.30, at least about 0.33, at least about 0.35, at least about 0.40, or at least about 0.45 at 20° C. Loss factor is measured by Mechanical Impedance Measurement as described in ISO Standard 16940. To measure damping loss factor, a polymer sample is laminated between two sheets of clear glass, each having a thickness of 2.3 mm (or other glass thicknesses as desired), and is prepared to have a width of 25 mm and a length of 300 mm. The laminated sample is then excited at the center point using a vibration shaker (commercially available from Brüel and Kjær (Nærum, Netherlands)) and an impedance head (Brüel and Kjær) is used to measure the force required to excite the bar to vibrate and the velocity of the vibration. The resultant transfer function is recorded on a National Instrument data acquisition and analysis system and the loss factor at the first vibration mode is calculated using the half power method.

Multiple layer panels as described herein may be formed by any suitable method. The typical glass lamination process comprises the following steps: (1) assembly of the two (or more) substrates and the interlayers; (2) heating the assembly via an IR radiant or convective device for a first, short period of time; (3) passing the assembly into a pressure nip roll for the first de-airing; (4) heating the assembly for a short period of time to an appropriate temperature (such as about 60° C. to about 120° C.) to give the assembly enough temporary adhesion to seal the edge of the interlayer; (5) passing the assembly into a second pressure nip roll to further seal the edge of the interlayer and allow further handling; and (6) autoclaving the assembly at an appropriate temperature (such as between 135° C. and 150° C.) and appropriate pressure (such as between 150 psig and 200 psig) for about 30 to 90 minutes. Other methods for de-airing the interlayer-glass interface, as described according to one embodiment in steps (2) through (5) above include vacuum bag and vacuum ring processes, and both may also be used to form interlayers of the present invention as described herein.

The multiple layer panels of the present invention can be used for a variety of end use applications, including, for example, for automotive windshields and windows, aircraft windshields and windows, panels for various transportation applications such as marine applications, rail applications, etc., structural architectural panels such as windows, doors, stairs, walkways, balusters, decorative architectural panels, weather-resistant panels, such as hurricane glass or tornado glass, ballistic panels, and other similar applications.

The following examples are intended to be illustrative of the present invention in order to teach one of ordinary skill in the art to make and use the invention and are not intended to limit the scope of the invention in any way.

The invention also includes Embodiments 1 to 13, below.

Embodiment 1 is a multiple layer acoustic interlayer for a sound insulating asymmetric multiple layer panel comprising: a first stiff layer having a first stiff layer thickness, a second stiff layer having a second stiff layer thickness, a soft layer between the first and second stiff layers, wherein the soft layer is non-centrally located.

Embodiment 2 is a multiple layer acoustic interlayer including the features of Embodiment 1, wherein the glass transition temperature of the soft layer is less than 20° C.

Embodiment 3 is a multiple layer acoustic interlayer including any of the features of Embodiments 1 and 2, wherein the first stiff layer thickness is less than the second stiff layer thickness.

Embodiment 4 is a multiple layer acoustic interlayer including any of the features of Embodiments 1 to 3, wherein the soft layer has a geometric center location, and wherein the interlayer has a first thickness t₁ that is the thickness from the geometric center location to an outer surface of the first stiff layer, and a second thickness t₂ that is the thickness from the geometric center location to an outer surface of the second stiff layer, wherein the ratio of t₂ to t₁ is less than 1.

Embodiment 5 is a multiple layer acoustic interlayer including any of the features of Embodiments 1 to 4, wherein the ratio of t₂ to t₁ is less than 0.8.

Embodiment 6 is a multiple layer acoustic interlayer including any of the features of Embodiments 1 to 5, wherein the interlayer further comprises a third stiff layer and a second soft layer, wherein the second soft layer is positioned between the second stiff layer and the third stiff layer.

Embodiment 7 is a multiple layer acoustic interlayer including the features of Embodiment 6, wherein the second soft layer is non-centrally located.

Embodiment 8 is an asymmetric multiple layer panel comprising: a first rigid substrate having a first thickness H₃, a second rigid a second rigid substrate having a second thickness H₁, wherein H₃<H₁, and a multiple layer acoustic interlayer including any of the features of Embodiments 1 to 7.

Embodiment 9 is a multiple layer acoustic interlayer for a sound insulating asymmetric multiple layer panel comprising: a first stiff layer having a first stiff layer thickness, a second stiff layer having a second stiff layer thickness, a third stiff layer having a third stiff layer thickness, a first soft layer between the first and second stiff layers, a second soft layer between the second and third stiff layers, wherein at least one of the first and second soft layers is non-centrally located.

Embodiment 10 is multiple layer acoustic interlayer including the features of Embodiment 9, wherein the interlayer further comprises a fourth stiff layer and a third soft layer, wherein the third soft layer is positioned between the third stiff layer and the fourth stiff layer.

Embodiment 11 is a asymmetric sound insulating multiple layer panel comprising: a first rigid substrate having a first thickness H₃, a second rigid substrate having a second thickness H₁, wherein H₃<H₁, and an asymmetric multiple layer acoustic interlayer between the first and second rigid substrates, wherein the multiple layer comprises a first stiff layer having a first stiff layer thickness, a second stiff layer having a second stiff layer thickness, and a soft layer between the first and second stiff layers, and wherein the soft layer is non-centrally located.

Embodiment 12 is a multiple layer panel including the features of Embodiment 11, wherein the first and second rigid substrates are glass.

Embodiment 13 is a multiple layer panel including any of the features of Embodiments 11 and 12, wherein the ratio of H₃ to H₁ is from 0.23 to 0.95.

### EXAMPLES

The following Examples describe the preparation of multiple layer glass panels and interlayers. As described below, several tests performed on the glass panels were used to evaluate the acoustic properties of several comparative and disclosed symmetric multiple layer glass panels.

Monolithic and multilayer (tri-layer) PVB sheets were produced by the following methods. Several monolithic sheets were formed by melt blending PVB resin with plasticizer(s) (types and amounts shown in Table 1). The resulting plasticized resins were each extruded to form polymer sheets. Several three-layer (or tri-layer) sheets were also formed by coextruding a first PVB resin and a second PVB resin, each of which had been melt blended with plasticizer(s) (types and amounts shown in Table 1). The resulting multiple layer interlayers included two outer skin layers formed from one PVB resin with an inner core layer formed from the other PVB resin between the two outer layers. Table 1 summarizes the PVB sheet compositions for PVB-1 to PVB-7 and shows the individual layers (for multilayer sheets) and thicknesses. PVB-2, PVB-3, PVB-5, and PVB-6 are symmetrically configured acoustic multilayer PVB sheets having skin/core/skin (or stiff/soft/stiff) layer configurations (the core or soft layer is located at the center position of the sheet). PVB-1, PVB-4 and PVB-7 are monolithic PVB sheets. The PVB sheets, alone or in combination, were used to construct various multilayer glass panels in Examples 1 to 4 described below. Results are shown in Tables 2 to Table 5 below.

TABLE 1
Acoustic (Stiff/Soft/Stiff) Tri-layer Sheet and Monolithic Sheet Compositions

| Sheet No | PVB-1 | PVB-2 | PVB-3 | PVB-4 | PVB-5 | PVB-6 | PVB-7 |
|---|---|---|---|---|---|---|---|
| Skin layer resin residual hydroxyl content (wt. | 18.5 | 18.5 | 24 | 18.5 | 18.5 | 22 | 22 |
| %) | | | | | | | |
| Skin layer 3GEH PZ content (phr) | 38 | 38 | — | 38 | 38 | 28 | 28 |
| Skin layer B9-88/3GEH (60/40) PZ content | — | — | 36 | — | — | — | — |
| (phr) | | | | | | | |
| Core layer resin residual hydroxyl content (wt. | — | 10.5 | 9 | — | 10.5 | 9 | — |
| %) | | | | | | | |
| Core layer 3GEH PZ content (phr) | — | 75 | — | — | 75 | 70 | — |
| Core layer B9-88/3GEH (60/40) PZ content | — | — | 80 | — | — | — | — |
| (phr) | | | | | | | |
| Core layer thickness (mm) | — | 0.11 | 0.11 | — | 0.089 | 0.11 | — |
| Total sheet thickness (H₂, mm) | 0.76 | 0.84 | 0.84 | 0.38 | 0.50 | 0.84 | 0.76 |
| Skin layer glass transition temperature (° C.) | 30 | 30 | 41 | 30 | 30 | 42 | 42 |
| Symmetry of soft (core) layer (Sₗ = t₂/t₁) | — | 1 | 1 | — | 1 | 1 | — |
| Core layer glass transition temperature (° C.) | — | −2 | −2 | — | −2 | −2 | — |

PZ: Plasticizer (3GEH is triethylene glycol di-(2-ethylhexanoate) and B9-88 is Benzoflex ™ 9-88 plasticizer)

### Example 1

### Glass Panels of Reduced Symmetry and Symmetric Acoustic Tri-layer Interlayer

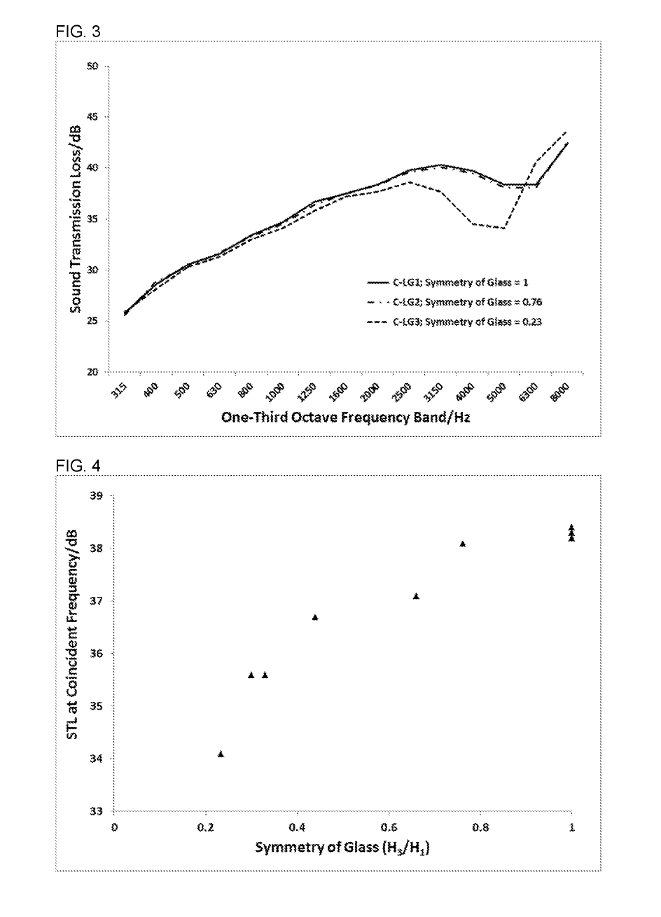

Comparative multilayer glass panels C-LG1 to C-LG3 of varying symmetry of glass (S_{G}) levels from 0.23 to 1 were produced by laminating an acoustic PVB sheet (PVB-2, symmetry of core=1) between two clear glass panel pairs (500 mm by 800 mm) of varying thicknesses, as shown in Table 2 below. The sound transmission loss of each of the comparative multilayer glass panels was measured (according to the procedure described by ASTM E90 at 20° C.) for various frequencies over a range of 200 Hz to 10,000 Hz. The damping loss factor (η) was measured (on a 25 mm×300 mm laminated bar at 20° C. by Mechanical Impedance Measurement as described in ISO 16940). Coincident frequency and sound transmission loss at coincident frequency from STL measurement are summarized in Table 2. Plots in the 315 to 8000 Hz third-octave band frequency region are shown in FIG. 3.

TABLE 2
Comparative Multilayer Glass Panel Constructions
and Sound Insulation Properties

| Laminated glass panel | C-LG1 | C-LG2 | C-LG3 |
|---|---|---|---|
| Interlayer | PVB-2 | PVB-2 | PVB-2 |
| Interlayer thickness (H₂, mm) | 0.84 | 0.84 | 0.84 |
| Symmetry of soft layer (S_{I} = t₂/t₁) | 1 | 1 | 1 |
| Glass configuration H₃/H₁ (mm/mm) | 1.85/1.85 | 2.1/1.6 | 3.0/0.7 |
| Combined glass thickness (mm) | 3.7 | 3.7 | 3.7 |
| Symmetry of glass (S_{G} = H₃/H₁) | 1 | 0.76 | 0.23 |
| Surface density (kg/m²) | 10.1 | 10.1 | 10.1 |
| Coincident frequency (Hz) | 5000-6300 | 6300 | 5000 |
| TL at coincident frequency (dB) | 38.4 | 38.1 | 34.1 |

As shown in Table 2, varying the thickness of the individual glass sheets while maintaining the same combined glass thickness of multilayer panels comprising a symmetrical acoustic multilayer interlayer resulted in a significant change in sound transmission loss at the coincident frequency as the symmetry of glass, S_{G}, decreased. For example, as shown by comparing panel C-LG1 with panels C-LG2 and C-LG3, the transmission loss at coincident frequency decreased as the symmetry of glass decreased from 1 to 0.23. FIG. 3 provides a graphical representation of TL at the coincident frequency. As shown in Table 2 and in FIG. 3, the minimum symmetry of glass at which the comparative panels exhibited a sound transmission loss at the coincident frequency of at least 34 dB is 0.23. It is expected that the sound transmission loss at the coincident frequency for similar panels having symmetries less than 0.23 would be less than 34 dB, and this is generally not suitable for use in applications requiring acoustic performance (i.e. good sound insulation properties).

### Example 2

### Asymmetric Glass Panels and Symmetric Acoustic Tri-layer Interlayer

Additional comparative multilayer glass panels C-LG4 to C-LG10 were produced in the same manner as in Example 1 by laminating PVB-2 between two glass sheets to form multilayer panels of varying symmetry of glass and combined glass thicknesses of from 2.3 to 4.6 mm. Details of the panels are summarized in Table 3, below (C-LG1 to C-LG3 from Example 1 are also included in Table 3). The sound transmission loss and damping loss factor (η) were measured as previously described, and results are summarized in Table 3 below.

TABLE 3
Comparative Glass Panel Constructions and Sound Insulation Properties

| Laminated glass panel | C-LG4 | C-LG5 | C-LG1 | C-LG6 | C-LG2 | C-LG7 | C-LG8 | C-LG9 | C-LG10 | C-LG3 |
|---|---|---|---|---|---|---|---|---|---|---|
| Interlayer | PVB-2 | PVB-2 | PVB-2 | PVB-2 | PVB-2 | PVB-2 | PVB-2 | PVB-2 | PVB-2 | PVB-2 |
| Interlayer thickness (H₂, mm) | 0.84 | 0.84 | 0.84 | 0.84 | 0.84 | 0.84 | 0.84 | 0.84 | 0.84 | 0.84 |
| Symmetry of soft layer (Sₗ = | 1 | 1 | 1 | 1 | 1 | 1 | 1 | 1 | 1 | 1 |
| t₂/t₁) | | | | | | | | | | |
| Glass configuration (H₃/H₁, | 2.3/2.3 | 2.1/2.1 | 1.85/1.85 | 0.7/0.7 | 2.1/1.6 | 1.9/1.25 | 1.6/0.7 | 2.1/0.7 | 2.3/0.7 | 3.0/0.7 |
| mm/mm) | | | | | | | | | | |
| Combined glass thickness | 4.6 | 4.2 | 3.7 | 1.4 | 3.7 | 3.2 | 2.3 | 2.8 | 3 | 3.7 |
| (mm) | | | | | | | | | | |
| Symmetry of glass (S_{G} = H₃/H₁) | 1 | 1 | 1 | 1 | 0.76 | 0.66 | 0.44 | 0.33 | 0.30 | 0.23 |
| Surface density (kg/m²) | 12.4 | 11.4 | 10.1 | 4.4 | 10.1 | 8.9 | 6.6 | 7.9 | 8.4 | 10.1 |
| Damping loss factor at 20° C. | 0.31 | 0.31 | 0.3 | — | 0.28 | 0.26 | — | — | — | — |
| Coincident frequency (Hz) | 5000 | 5000 | 5000-6300 | 8000 | 5000 | 6300 | 8000 | 6300 | 6300 | 5000 |
| TL at coincident frequency (dB) | 38.3 | 38.2 | 38.4 | 38.2 | 38.1 | 37.1 | 36.7 | 35.6 | 35.6 | 34.1 |

As shown by a comparison of panels C-LG1 and C-LG4 to C-LG6, the sound transmission loss at the coincident frequency of the panels appears to be independent of glass thickness. As shown in Table 3, C-LG1 and C-LG4 to C-LG6 all have a symmetry of glass (S_{G}) of 1, but all have different combined glass thicknesses (4.6 mm for C-LG4, 4.2 mm for C-LG5, 3.7 mm for C-LG1, and 1.4 mm for C-LG6). Despite the differences in combined glass thickness, these panels all exhibited a similar sound transmission loss (of about 38.2 to 38.4 dB) at the coincident frequency. The damping loss factors of panels C-LG1, C-LG4 and C-LG5 are about 0.30 to 0.31, which is consistent with the sound transmission loss values measured. Therefore, adjusting the combined glass thickness alone does not sufficiently alter the sound transmission loss of the panels.

Reducing the symmetry of glass by changing the thickness of glass in the panels (for example, by reducing the thickness of glass in C-LG1 and C-LG4, C-LG5 and C-LG6 to create comparative panels C-LG2, C-LG3 and C-LG7 to C-LG10) resulted in decreasing sound transmission loss levels. As shown by the data in Table 3, as the symmetry of glass was reduced from 1 to 0.23, the sound transmission loss was reduced or decreased by as much as 4 dB. The decrease in the sound transmission loss at the coincident frequency is independent of the combined glass thickness. The sound transmission loss at the coincident frequency as a function of symmetry for panels C-LG1 to C-LG10 is summarized graphically in FIG. 4.

A similar dependency was also observed for damping loss factors with panels C-LG4, C-LG5, C-LG-2, and C-LG7, which have different symmetry of glass configurations. Panels C-LG4 and C-LG5 have S_{G} of 1 and a damping loss factor of 0.31. Comparing C-LG4 and C-LG5 to C-LG2 and C-LG6, the damping loss factor was reduced from 0.31 to 0.28 and 0.26, respectively, as S_{G} decreased from 1 to 0.76 and 0.66 respectively. The data in Table 3 shows that damping loss factor generally correlates with sound insulation properties, and as shown increasing damping loss factor increases sound transmission loss at the coincident frequency of a laminated glass.

### Example 3

### Asymmetric Glass Panels and Asymmetric Acoustic Interlayers

Disclosed and additional comparative multilayer glass panels were produced by laminating PVB sheets (alone or in combination) between two sheets of glass of varying symmetries at a constant combined glass thickness level. The interlayers had varying symmetry of core layer values, as shown in Table 4. For example, comparative panels C-LG11 and C-LG12 had symmetric glass configurations (S_{G}=1) and symmetric interlayers (S₁=1) (using PVB-5 and PVB-6 respectively), and were produced by laminating the PVB sheet with two 2.1 mm glass sheets. Comparative panels C-LG13 and C-LG14 had asymmetric glass configurations (S_{G}=0.42) and symmetric interlayers (S₁=1) and were produced by laminating the PVB sheet between 3 mm and 1.25 mm glass sheets to form the multilayer glass panels. Comparative panels C-LG15 and C-LG16 also had asymmetric glass configurations (S_{G}=0.42) and symmetric interlayers (Sₗ=1), but the interlayers were produced by combining multiple PVB sheets (for C-LG15, PVB-5 was combined with one PVB-4 sheet on each side and for C-LG16, PVB-5 was combined with one PVB-1 sheet on each side to form a tri-layer interlayer).

To produce interlayers having different (reduced) symmetry of core layer values, either PVB-5 or PVB-6 was laminated with one or more PVB sheets of different composition and thickness, as shown in Table 4, to create asymmetric interlayers. The asymmetric interlayers were then used to produce disclosed panels D-LG1 to D-LG6. Asymmetric glass panels D-LG1 and D-LG5 were produced by laminating the asymmetric interlayer between 3 mm and 1.25 mm glass sheets (for D-LG1, S_{G}=0.42, Sₗ=0.25 and for D-LG5, S_{G}=0.42, Sₗ=0.14). The core layers in both disclosed panels D-LG1 and D-LG5 were located closer to the thinner glass sheet. D-LG2 (S_{G}=0.42, Sₗ=0.25) and D-LG6 (S_{G}=0.42, Sₗ=0.14) were produced with the same glass sheets and asymmetric interlayers as D-LG1 and D-LG5 except that the core layers were located closer to the thicker glass sheet. Similarly, D-LG3 and D-LG4 were produced by laminating another asymmetric PVB (formed by combining PVB-6 with PVB-7) between 3 mm and 1.25 mm glass sheets with the core layer closer to the thinner glass sheet for D-LG3 (S_{G}=0.42, Sₗ=0.35) and closer to the thicker glass sheet for D-LG4 (S_{G}=0.42, Sₗ=0.35). (Note that the interlayers with the asymmetric core layers could also be produced through co-extrusion instead of laminating multiple sheets together to form the interlayers.) The resulting panels were tested for damping loss factor as previously described, and test results and details of the panels are summarized in Table 4, below.

TABLE 4
Comparative and Disclosed Glass Panel Constructions and Sound Insulation Properties

| Laminated | | Interlayer | Symmetry of | Glass | | Symmetry of | Surface | |
|---|---|---|---|---|---|---|---|---|
| glass | | thickness | soft layer | configuration | Combined glass | glass | Density | Damping loss |
| panel | Interlayer | (H₂, mm) | (Sₗ = t₂/t₁) | (mm/mm) | thickness (mm) | (S_{G} = H₃/H₁) | (kg/m²) | factor at 20° C. |
| C-LG11 | PVB-5 | 0.5 | 1 | 2.1/2.1 | 4.2 | 1 | 11.0 | 0.26 |
| C-LG12 | PVB-6 | 0.83 | 1 | 2.1/2.1 | 4.2 | 1 | 11.4 | 0.27 |
| C-LG13 | PVB-5 | 0.5 | 1 | 3.0/1.25 | 4.2 | 0.42 | 11.0 | 0.20 |
| C-LG14 | PVB-6 | 0.83 | 1 | 3.0/1.25 | 4.2 | 0.42 | 11.4 | 0.21 |
| C-LG15 | PVB-4/PVB-5/PVB-4 | 1.26 | 1 | 3.0/1.25 | 4.2 | 0.42 | 11.8 | 0.21 |
| C-LG16 | PVB-1/PVB-5/PVB-1 | 2.02 | 1 | 3.0/1.25 | 4.2 | 0.42 | 12.7 | 0.22 |
| D-LG1 | PVB-1/PVB-5 | 1.26 | 0.25 | 3.0/1.25 | 4.2 | 0.42 | 11.8 | 0.23 |
| D-LG2 | PVB-5/PVB-1 | 1.26 | 0.25 | 3.0/1.25 | 4.2 | 0.42 | 11.8 | 0.24 |
| D-LG3 | PVB-7/PVB-6 | 1.6 | 0.35 | 3.0/1.25 | 4.2 | 0.42 | 12.2 | 0.26 |
| D-LG4 | PVB-6/PVB-7 | 1.6 | 0.35 | 3.0/1.25 | 4.2 | 0.42 | 12.2 | 0.25 |
| D-LG5 | PVB-1/PVB-1/PVB-5 | 2.02 | 0.14 | 3.0/1.25 | 4.2 | 0.42 | 12.7 | 0.26 |
| D-LG6 | PVB-5/PVB-1/PVB-1 | 2.02 | 0.14 | 3.0/1.25 | 4.2 | 0.42 | 12.7 | 0.25 |

As shown in Table 4, comparative panels C-LG11 and C-LG12, which have symmetric glass configurations and symmetric acoustic interlayers exhibit damping loss factors of 0.26 and 0.27 respectively. In contrast, asymmetric glass panels C-LG13 and C-LG14 have loss factors of 0.20 and 0.21, respectively, which are each 0.06 lower than the loss factors of the symmetric glass panels (C-LG11 and C-LG12) having the same symmetric interlayers. The reduction in damping loss factor as the symmetry of glass configuration is decreased from 1 (C-LG11 and C-LG12) to 0.42 (C-LG13 and C-LG14) is similar to the reduction in sound transmission loss at the coincident frequency exhibited by the multilayer glass panels shown in Table 2 and FIG. 4.

Further, the data shows that increasing overall interlayer thickness while maintaining a symmetric interlayer configuration (S₁=1) does not significantly or noticeably improve damping loss factor. For example, panels C-LG15 and C-LG16, which have symmetric interlayers (S₁=1) having thicknesses of 1.26 and 2.02 mm, respectively, exhibited damping loss factor values of 0.21 and 0.22, which is only slightly higher than that of C-LG13, which has an interlayer thickness of 0.5 mm, and is significantly lower than symmetrically configured panel C-LG11 (also having an interlayer thickness of 0.5 mm). In other words, in a multilayer glass panel having a low symmetry of glass and a symmetrically configured interlayer (the symmetry of core layer of 1), increasing interlayer thickness while maintaining the symmetry of core layer results in insignificant change in the damping loss factor of the panel.

Disclosed panels D-LG1 to D-LG6 (having asymmetric interlayers (with the symmetry of core layer of less than 1 and the core layer non-centrally located in the interlayer) and a combined glass thickness of 4.2 mm and symmetry of glass of 0.42), on the other hand, exhibited damping loss factors higher than the panels having same asymmetric glass configuration but symmetric acoustic interlayers (see, for example, comparative panels C-LG13 and C-LG16). As shown by the data in Table 4, using an asymmetric acoustic interlayer improves sound insulation properties of asymmetric multilayer glass panels. For example, disclosed panels D-LG1 and D-LG2 (symmetry of core layer of 0.25, interlayer thickness of 1.26 mm, and symmetry of glass of 0.42) exhibited damping loss factors of 0.23 and 0.24, respectively, which are 0.02 to 0.04 higher than the comparative panels C-LG13 to C-LG16 (having the same symmetry of glass but symmetry of core layer of 1 and interlayer thicknesses ranging from 0.5 to 2.02 mm). Similarly, disclosed panels D-LG3 and D-LG4 (symmetry of core layer of 0.35, symmetry of glass of 0.42, and interlayer thickness 1.6 mm) exhibited damping loss factors of 0.26 and 0.25, respectively, which are similar to the loss factor of the symmetrically configured glass panel C-LG12 (having a damping loss factor of 0.27). Disclosed panels D-LG5 and D-LG6 (symmetry of core layer of 0.14, symmetry of glass of 0.42, and interlayer thickness of 2.02) exhibited damping loss factors of 0.26 and 0.25, respectively, which are essentially the same as the damping loss factor of the symmetrically configured panel C-LG11 (damping loss factor of 0.26), and 0.03 to 0.04 higher than comparative panel C-LG16 that has the same interlayer thickness but a symmetric core layer configuration.

In each pair of disclosed panels (D-LG1 and D-LG2, D-LG3 and D-LG4, and D-LG5 and D-LG6), the core layer position in the asymmetric interlayers was either located toward the thinner glass (1.25 mm, as in D-LG1, D-LG3, and D-LG5) or toward the thicker glass (3.0 mm, as in D-LG2, D-LG4, and D-LG6), but despite the different core layer position, the damping loss factors of each pair of the disclosed panels was very similar (or stated differently, core layer position of the asymmetric interlayers had little effect on the damping loss factor). Thus, asymmetric multilayer interlayers are especially effective at improving sound insulation of asymmetric glass panels.

### Example 4

### Asymmetric Glass Panels and Asymmetric Acoustic Interlayers

Additional disclosed panels as shown in Table 5 were produced in the same manner as in Example 3. Comparative panels C-LG3 and C-LG4 (from Table 3) are also included in Table 5. The asymmetric core layer of the interlayers of disclosed panels D-LG7 and D-LG8 was created by laminating PVB-2 with one sheet of monolithic PVB-1 (D-LG7) or with two sheets of monolithic PVB-1 (D-LG8). Interlayers having multiple core layers of different core layer symmetries for disclosed multilayer panels D-LG9 and D-LG10 were produced by combining three PVB-3 tri-layer sheets, resulting in an interlayer having three core layers (with the symmetries of core layers of 0.2, 1, and 0.2 respectively). (As previously noted, these interlayers could be produced by co-extrusion.) The panels were tested for coincident frequency and sound transmission loss at coincident frequency, and results and details of the panels are summarized in Table 5, below.

TABLE 5
Glass Constructions and Sound Insulation Properties

| | | | | | Combined | | | | TL at |
|---|---|---|---|---|---|---|---|---|---|
| | | Interlayer | Symmetry | Glass | glass | Symmetry of | Surface | Coincident | coincident |
| Laminated | | thickness | of soft layer | configuration | thickness | glass | density | frequency | frequency |
| glass panel | Interlayer | (H₂, mm) | (Sₗ = t₂/t₁) | (mm/mm) | (mm) | (S_{G} = H₃/H₁) | (kg/m²) | (Hz) | (dB) |
| C-LG3 | PVB-2 | 0.83 | 1 | 3.0/0.7 | 3.7 | 0.23 | 10.1 | 5000 | 34.1 |
| D-LG7 | PVB-2/PVB-1 | 1.59 | 0.35 | 3.0/0.7 | 3.7 | 0.23 | 10.9 | 4000 | 35.8 |
| D-LG8 | PVB-2/PVB-1/PVB-1 | 2.35 | 0.22 | 3.0/0.7 | 3.7 | 0.23 | 11.8 | 4000 | 36.8 |
| D-LG9 | PVB-3/PVB-3/PVB-3 | 2.49 | 0.2; 1; 0.2 | 3.0/0.7 | 3.7 | 0.23 | 11.9 | 4000 | 38.3 |
| C-LG4 | PVB-2 | 0.83 | 1 | 2.3/2.3 | 4.6 | 1 | 12.4 | 5000 | 38.3 |
| D-LG10 | PVB-3/PVB-3/PVB-3 | 2.49 | 0.2; 1; 0.2 | 2.1/1.6 | 3.7 | 0.76 | 11.9 | 5000 | 41 |

As shown in Table 5, comparative panel C-LG3 has a symmetry of core layer of 1, combined glass thickness of 3.7 mm and a symmetry of glass of 0.23. Disclosed panels D-LG7 and D-LG8 have the same asymmetric glass configurations as C-LG3, but the interlayers are asymmetric acoustic interlayer configurations (symmetry of core layer of 0.35 and 0.22, respectively). The disclosed panels D-LG7 and D-LG8 had sound transmission losses of 35.8 and 36.8 dB at the coincident frequency, which are an increase of 1.7 and 2.7 dB compared to comparative panel C-LG3. This improvement in sound transmission loss at the coincident frequency is similar to the improvement in damping loss factors observed with asymmetric glass panels having asymmetric interlayers (as shown Table 4 and discussed above). As shown, the sound transmission loss of an asymmetric laminated glass panel can be improved by the use of an asymmetric interlayer (having the core layer non-centrally located in the interlayer).

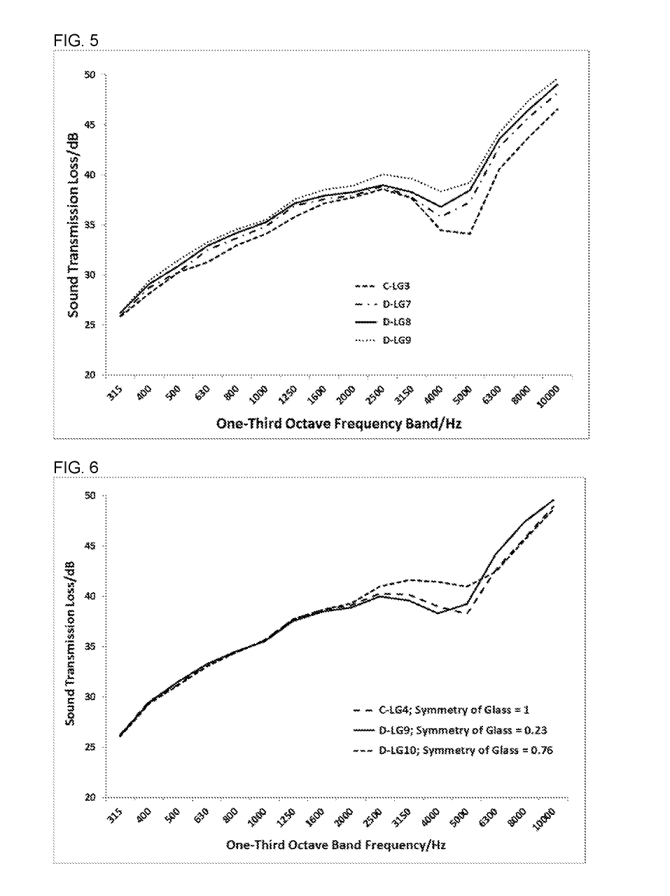

Disclosed panel D-LG9, having the same asymmetric glass configuration as D-LG7 and D-LG8 and three core layers in the interlayer (with the symmetries of core layer of 0.2, 1, and 0.2) exhibited a sound transmission loss of 38.3 dB at the coincident frequency, a further increase of 1.5 dB over D-LG8. As shown by disclosed panel D-LG9, an interlayer with more than one core layer and having at least one asymmetric core layer configuration further improved sound transmission loss at the coincident frequency compared to an asymmetric glass panel having an asymmetric interlayer with only one core layer. The sound transmission loss at the coincident frequency for panels C-LG3, D-LG7 through D-LG9 is also summarized graphically in FIG. 5.

As further shown in Table 5, disclosed panel D-LG9, which had more than one asymmetric core layer, symmetry of glass of 0.23 and surface density of 11.9 kg/m², exhibited a sound transmission loss at the coincident frequency of 38.3 dB, which is equivalent to that of comparative multilayer glass panel C-LG4, which had a symmetric interlayer configuration, symmetric glass configuration and a surface density of 12.4 kg/m² (slightly heavier than D-LG9).

The same interlayer as used in D-LG9, (with three soft layers (two asymmetric and one symmetric)), when laminated between two sheets of glass to form a panel having a higher symmetry of glass (S_{G}=0.76) further improved sound transmission loss at the coincident frequency by as much as 2.7 dB. The plot of sound transmission loss curves for D-LG9, D-LG10, and C-LG4 in the frequency range of 315 to 10000 Hz is shown in FIG. 6.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention

It will further be understood that any of the ranges, values, or characteristics given for any single component of the present disclosure can be used interchangeably with any ranges, values or characteristics given for any of the other components of the disclosure, where compatible, to form an embodiment having defined values for each of the components, as given herein throughout. For example, an interlayer can be formed comprising poly(vinyl butyral) having a residual hydroxyl content in any of the ranges given in addition to comprising a plasticizers in any of the ranges given to form many permutations that are within the scope of the present disclosure, but that would be cumbersome to list. Further, ranges provided for a genus or a category, such as phthalates or benzoates, can also be applied to species within the genus or members of the category, such as dioctyl terephthalate, unless otherwise noted.

1.-14. (canceled)

15. An asymmetric sound insulating multiple layer panel comprising:
a first rigid substrate having a first thickness H₃,
a second rigid substrate having a second thickness H₁, wherein H₃<H₁,
and an asymmetric multiple layer acoustic interlayer between the first and second rigid substrates, wherein the multiple layer comprises a first stiff layer having a first stiff layer thickness, a second stiff layer having a second stiff layer thickness, and a soft layer between the first and second stiff layers, and wherein the soft layer is non-centrally located, wherein the glass transition temperature of the soft layer is less than 20° C., wherein the multiple layer panel has a sound transmission loss at the coincident frequency, measured according to ASTM E90 at 20° C. and panel dimensions of 50 cm by 80 cm, that is greater than the sound transmission loss of a multiple layer panel comprising at least one of a multiple layer interlayer wherein the soft layer is centrally located or a multiple layer panel comprising rigid substrates wherein H₁=H₃.

16. The multiple layer panel of claim 15, wherein the first and second rigid substrates are glass.

17. The multiple layer panel of claim 15, wherein the ratio of H₃ to H₁ is from 0.23 to 0.95.

18. The multiple layer panel of claim 15, wherein the soft layer of the interlayer has a geometric center location, and wherein the interlayer has a first thickness t₁ that is the thickness from the geometric center location to an outer surface of the first stiff layer, and a second thickness t₂ that is the thickness from the geometric center location to an outer surface of the second stiff layer, wherein the ratio of t₂ to t₁ is less than 1.

19. The multiple layer panel of claim 18, wherein the ratio of t₂ to t₁ is less than 0.8.

20. (canceled)

21. The multiple layer acoustic panel of claim 15, wherein the first stiff layer thickness is less than the second stiff layer thickness.

22. The multiple layer acoustic panel of claim 15, wherein the soft layer has a geometric center location, and wherein the interlayer has a first thickness t₁ that is the thickness from the geometric center location to an outer surface of the first stiff layer, and a second thickness t₂ that is the thickness from the geometric center location to an outer surface of the second stiff layer, wherein the ratio of t₂ to t₁ is less than 1.

23. The multiple layer acoustic interlayer of claim 22, wherein the ratio of t₂ to t₁ is less than 0.8.

24. The multiple layer acoustic interlayer of claim 15, wherein the interlayer further comprises a third stiff layer and a second soft layer, wherein the second soft layer is positioned between the second stiff layer and the third stiff layer.

25. The multiple layer acoustic interlayer of claim 24, wherein the second soft layer is non-centrally located.

26. An asymmetric sound insulating multiple layer panel comprising:
a first rigid substrate having a first thickness H₃,
a second rigid substrate having a second thickness H₁, wherein H₃<H₁,
and an asymmetric multiple layer acoustic interlayer between the first and second rigid substrates, wherein the multiple layer interlayer comprises:
a first stiff layer having a first stiff layer thickness,
a second stiff layer having a second stiff layer thickness,
a third stiff layer having a third stiff layer thickness,
a first soft layer between the first and second stiff layers,
a second soft layer between the second and third stiff layers,
wherein the glass transition temperature of at least one of the soft layers is less than 20° C.,
wherein at least one of the first and second soft layers is non-centrally located,
wherein the multiple layer panel has a sound transmission loss at the coincident frequency, measured according to ASTM E90 at 20° C. and panel dimensions of 50 cm by 80 cm, that is greater than the sound transmission loss of a multiple layer panel comprising at least one of a multiple layer interlayer wherein the soft layer is centrally located or a multiple layer panel comprising rigid substrates wherein H₁=H₃.

27. The multiple layer acoustic panel of claim 26, wherein the first stiff layer thickness is less than the second stiff layer thickness.

28. The multiple layer acoustic panel of claim 26, wherein the first soft layer has a geometric center location, and wherein the interlayer has a first thickness ti that is the thickness from the geometric center location to an outer surface of the first stiff layer, and a second thickness t₂ that is the thickness from the geometric center location to an outer surface of the second stiff layer, wherein the ratio of t₂ to t₁ is less than 1.

29. The multiple layer acoustic panel of claim 28, wherein the ratio of t₂ to t₁ is less than 0.8.

30. The multiple layer acoustic panel of claim 26, wherein the interlayer further comprises a fourth stiff layer and a third soft layer, wherein the third soft layer is positioned between the third stiff layer and the fourth stiff layer.
